(19) United States
(12) Patent Application Publication
(10) Pub. No.: US 2010/0179875 A1
(43) Pub. Date: Jul. 15, 2010

(54) ADVERTISEMENT MATCHING SYSTEM BASED ON VIEWING HISTORY, PROGRAM, SERVER, AND ADVERTISEMENT PROVIDING METHOD

(76) Inventors: Yuki Naito, Tokyo (JP); Genki Takiuchi, Tokyo (JP)

Correspondence Address: JORDAN AND HAMBURG LLP, 122 EAST 42ND STREET, SUITE 4000, NEW YORK, NY, 10168, US

(21) Appl. No.: 12/452,502

(22) PCT Filed: Jul. 10, 2008
(86) PCT No.: PCT/JP2008/062518

§ 371 Date: Mar. 30, 2010

(30) Foreign Application Priority Data
Jul. 12, 2007 (JP) 2007-183673
Nov. 14, 2007 (JP) 2007-295160

(51) Int. Cl. G06Q 30/00; G06Q 10/00; G06F 15/16

(52) U.S. Cl. 705/14.54; 705/14.53; 709/203

(57) ABSTRACT

Advertisement attribute information extracted in an advertisement distribution server (101) is transmitted to a viewing terminal (104), browser viewing history information and the viewing history candidate information that the advertiser has registered in association with each other in advance are matched when placing an advertisement, and the advertisement information included in the advertisement attribute information having the agreed viewing history URL as the viewing history candidate information is inserted into an advertising space on a Web page which is a medium. This, in providing Web advertising (Internet advertising), allows the advertiser to get higher advertising effectiveness, the medium to effectively use the advertising space, and the viewer to acquire an advertisement as useful information.

### TECHNICAL FIELD

This invention relates to an advertisement matching system, an advertisement matching program and a server used for the advertisement matching system and an advertisement providing method to provide an advertisement through an electric communication line, i.e. what is so called a Web advertisement (internet advertisement), which can produce a higher advertisement effect for advertisers, permit medium owners to use an advertisement space effectively and permit viewers to perceive an advertisement as useful information.

### BACKGROUND ART

With the recent remarkable development of the communication technologies, the advertisement on Web pages has captured multipronged attentions. For a conventional mass advertisement such as TVCF, for example, a target segmentation to improve the advertisement effect is so crucial that the advisability of placing an advertisement is generally determined in accordance with the contents, the time zone and the rating of each program.

This is an important subject also for the Web advertisement, and an increased reach (click rate) of an advertisement is an important matter of concern for both the advertiser and the medium owner. Among the Web advertisements, one of the biggest differences between the banner advertisement (the space for displaying the image or text linked to the site of the advertiser) and the conventional mass advertisement is that the advertisement needs to prompt a viewer to click the banner, i.e. to draw a view's proactive actions. The advertiser is naturally very desirous of producing the effect commensurate with the cost of placing the advertisement. The medium owner (Web page manager) who earns the advertisement profit as a result of viewers' clicking the banner advertisement also desires, as much as or, in some cases, more than the advertiser to improve the click rate.

To cause the proactive behavior of clicking by the viewer, it is desirable to display an advertisement relevant to a topic or an event of strong interest to the viewer in the advertisement space. Each Web page administered by a particular medium owner is normally generated based on some theme. In some cases of Weblog (what is called the blog) making personal diaries public, for example, the personal quality and attribute of the author are normally and necessarily reflected, and therefore, the theme involved (for example, “gourmet”, “car”, “travel” or “animation”) naturally unveils, although theme cannot be identified with some weblogs.

The viewer of the particular Web page is generally considered to view the page because he/she is interested, though slightly, in the particular theme. Specifically, the advertiser, before placing the advertisement on the particular Web page, has already carried out the target segmentation to some degree in accordance with the theme of the Web page. In other words, one method of improving the advertisement effect is considered to closely study the theme of the Web page in which the advertisement is to be placed. From the standpoint of the medium owner, the click rate is expected to increase by selecting an advertisement banner conforming to the content of his/her page.

As a service in keeping with this approach, a provider exists who provides an affiliate program (a code embedded in a HTML data; see Non-Patent Document 1) in which an advertisement banner corresponding to his/her Web page is automatically selected and placed in his/her Web page from among the advertisement banners relevant to various types of advertisers.

In the approach described above, an advertisement conforming to the content of the Web page is placed and the viewers of the Web page are presumed interested in the event described in the particular Web page. Nevertheless, such an approach cannot be considered a method whereby the advertiser can appeal directly to the viewers to which the advertiser truly wants to provide the advertisement information.

Consequently, a more direct method of appeal is considered in which a banner advertisement corresponding to the attribute or the behavioral pattern of the viewer is displayed.

As an advertisement method associated with this approach, as described in Patent Document 1, for example, a method using an advertisement selection apparatus has been proposed in which a HTTP request message is transmitted from the user along with the viewing history information generated from the viewing behavior of the user, and based on this viewing history information and such information as the platform used by the user and the time connected, the advertisement is selected. Also, a method has been proposed, as described in Patent Document 2, in which the information on the hobby/taste of each registered user is received from the registered user and stored in a customer data base in the system, while a Web page file group including the advertisement file to be placed on the Web page is stored, and based on the hobby/taste information, the advertisement is allotted to each registered user.

Patent Document 1: Japanese Patent Application Laid-Open No. 2001-43282

Patent Document 2: Japanese Patent Application No. 2002-92022

Non-Patent Document 1: Taka'aki Mizuno: “Mystery of Google: Affiliate Part” (Sotec, Co., LTD. Aug. 20, 2004, pp. 142-162)

### DISCLOSURE OF THE INVENTION

### Problem to Be Solved by the Invention

In the advertisement method described in Patent Document 1, however, an advertisement processing unit, under the control of ISP, stores the placed advertisement in an advertisement data base with each advertisement specified by a keyword and classified according to category, and the advertisement to be displayed is selected based on the keyword and the category. Therefore, the advertiser cannot arbitrarily determine the reach of his/her advertisement. Thus, this advertisement method fails to fully reflect the intention of the advertiser. Similarly, the method proposed by Patent Document 2, in which the genre of each advertisement is managed in an advertisement management table, poses the problem that the advertiser's intention may not be directly reflected.

Accordingly, it is an object of this invention to provide an advertisement matching system capable of providing the advertisement information most suitable for each viewer based on the history of the behavior of the viewer and permitting the advertiser to directly define a viewer group to whom the advertiser is truly desirous of providing the advertisement information, wherein the advertisement information more conforming to the interest of the viewer and more reflecting the intention of the advertiser is displayed, thereby improving cost effectiveness.

### Means for Solving the Problem

In order to solve the problem described above, this invention has the configuration described below.

(1) An advertisement matching system having a server and viewing terminals connected to the server through an electric communication line to match a Web advertisement and an advertisement space on a Web page, characterized in that:

the server includes a medium attribute information storage means for registering, as the information on a specific Web page, the medium attribute information containing at least the information on the URL of the Web page; an advertisement attribute information storage means which registers, as the information on a specific Web page, the advertisement attribute information containing at least the placement medium information on the URL of the Web page designated as a placement medium, the viewing history candidate information as a condition to display the advertisement and the advertisement information to be displayed; a medium/advertisement relation storage means which, on condition that the information on the URL of the Web page, contained in the medium attribute information, coincides with the placement medium information contained in the advertisement attribute information, stores by relating the coincident medium attribute information and the coincident advertisement attribute information to each other in compliance with an external command; an advertisement attribute information extraction means which extracts the advertisement attribute information in the case where the information on the URL contained in the viewing-requested medium information received from the viewing terminal coincides with the placement medium information contained in the advertisement attribute information stored in the medium/advertisement relation storage means; and an extracted advertisement attribute information transmission means which transmits the extracted advertisement attribute information to the viewing terminal that has transmitted the viewing-requested medium information; and

each of the viewing terminals includes a medium display viewing means for displaying and viewing the Web page received through the electric communication line, along with the Web advertisement transmitted from the server; a viewing history storage means activated at the time of activation of the medium display viewing means to store the viewing history of the URL of the Web page viewed using the medium display viewing means; and a viewing history confirmation means for confirming whether the viewing history candidate information contained in the extracted advertisement attribute information received from the server is contained in the viewing history stored in the viewing history storage means or not;

wherein the advertisement information contained in the advertisement attribute information containing, as the viewing history candidate information, the URL confirmed by the viewing history confirmation means to have the viewing history is displayed in an advertisement space on the Web page requested to view (first aspect).

(2) An advertisement providing method for providing the advertisement information stored in a server, by matching with an advertisement space on a Web page on a display device of each viewing terminal connected through an electric communication line, characterized by including:

the step in which the server stores the information relevant to a specific Web page as the medium attribute information containing at least the information on the URL of the Web page;

the step in which the server stores the advertisement attribute information relevant to a specific Web advertisement as the advertisement attribute information containing at least the placement medium information relevant to the URL of a Web page designated as a placement medium, the viewing history candidate information as a condition for displaying the advertisement and the advertisement information to be displayed;

the step in which, on condition that the information on the URL of the Web page contained in the medium attribute information coincides with the placement medium information contained in the advertisement attribute information, the server stores the coincident medium attribute information and the coincident advertisement attribute information related to each other in compliance with an external command;

the step in which the server extracts the advertisement attribute information in the case where the information on the URL of the Web page requested to view coincides with the placement medium information contained in the related and stored advertisement attribute information;

the step in which the server transmits the extracted advertisement attribute information to the viewing terminal which has transmitted the viewing-requested medium information;

the step in which the viewing terminal confirms whether the viewing history candidate information contained in the extracted advertisement attribute information received from the server is contained in the viewing history stored in the viewing history storage means of the specific viewing terminal; and

the step in which the viewing terminal displays, in an advertisement space on the Web page requested to view, the advertisement information contained in the advertisement attribute information containing, as the viewing history candidate information, the URL confirmed by the viewing terminal to have the viewing history (fifth aspect).

Also, the medium attribute information in the advertisement matching system or the advertisement providing method may contain the advertisement space information in the Web page (second and sixth aspects). In addition, the medium attribute information may further contain a Web site name, a category and a keyword (third and seventh aspects). Incidentally, in view of the fact that this advertisement matching may not be desired by the viewer in some cases, there may be provided a means in which the advertisement matching based on the viewing history is rejected by advance registration (fourth aspect).

(3) An advertisement matching program for displaying the advertisement information distributed from an advertisement distribution server, in an advertisement space on a Web page requested to view, is characterized in that a computer functions as a viewing history collation means in which the viewing history candidate information contained in the advertisement attribute information distributed from the server is collated with the viewing history information generated separately and also as an advertisement display means in which the advertisement information contained in the advertisement attribute information containing the viewing history candidate information confirmed as coincident by the viewing history collation means is displayed in the advertisement space on the Web page requested to view (eighth aspect).

(4) An advertisement display program for displaying the advertisement information distributed from an advertisement distribution server, in a specific advertisement space in the case where a specific condition is met, characterized in that a computer functions as a viewing history collation means in which the viewing history candidate information contained in the advertisement attribute information distributed from the server is collated with the viewing history information generated separately and also as an advertisement display means for displaying the advertisement information contained in the advertisement attribute information containing the viewing history candidate information confirmed as coincident by the viewing history collation means, wherein the specific condition is the coincidence between the viewing history candidate information distributed from the server and the viewing history information generated separately, as the result of collation by the computer between the viewing history candidate information and the viewing history information, and wherein the specific advertisement space is predefined on the Web page of the URL requested to view and constituting the URL designated as a placement medium contained in the advertisement attribute information (ninth aspect).

(5) An advertisement distribution server for distributing the advertisement medium information containing the advertisement information meeting a specific condition to each viewing terminal, characterized by including: a medium attribute information storage means which registers the medium attribute information on a specific Web page; an advertisement attribute information storage means which registers, as the information on a specific Web advertisement, the advertisement attribute information containing at least the information on the URL of the Web page with the advertisement to be displayed thereon, the viewing history candidate information as a condition for displaying the advertisement and the advertisement information to be displayed; a medium/advertisement relation storage means which, on condition that the information on the URL of the Web page contained in the medium attribute information is coincident with the information on the URL of the Web page contained in the advertisement attribute information to display the advertisement, stores by relating the coincident medium attribute information and the coincident advertisement attribute information to each other in compliance with an external command; an advertisement attribute information extraction means for extracting the advertisement attribute information stored in the medium/advertisement relation storage means in the case where the information on the URL contained in the viewing-requested medium information received from the viewing terminal is coincident with the information on the URL of the Web page for displaying the advertisement contained in the advertisement attribute information stored in the medium/advertisement relation storage means; and an extracted advertisement attribute information transmission means for transmitting the extracted advertisement attribute information to the viewing terminal which has transmitted the viewing-requested medium information (tenth aspect).

Also, the medium attribute information in the server according to this invention may contain the advertisement space information in the Web page (eleventh aspect). In addition, the medium attribute information may contain a Web site name, a Web site URL, a category and a keyword.

Incidentally, as far as the privacy problem is ignored, a configuration can be employed on the server to take charge of the viewing history confirmation means and the step of collating the viewing history candidate information with the viewing history (thirteenth, fourteenth and fifteenth aspects).

Meanwhile, in this embodiment, the “electric communication line” indicates any type of such line including the ADSL (Asymmetric Digital Subscriber Line), the optical communication or other physical transmission path for wired or wireless communication. The “viewing terminal” may be the hardware having at least a display device such as a display, a Web browser for viewing Web pages and a communication means connected to the electric communication line to acquire the Web page information, and specifically includes a computer (hereinafter referred to as the PC (Personal Computer)), a portable information terminal (hereinafter referred to as the PDA (Personal Digital Assistant)) or a portable phone (including the PHS: Personal Handy-phone System) and the like.

The “Web advertisement” indicates an advertisement on a Web page which is mainly a banner advertisement (an image with a link having the function of introducing other Web sites on a Web page). Nevertheless, the Web advertisement is not limited to such an advertisement and may be a text displayed in a specific space. The “Web page” indicates a document described on Web pages mainly using a hypertext description language such as HTML (Hyper Text Markup Language) or XHTML (Extensive Hyper Text Markup Language).

The “advertisement space” indicates a vacant space for displaying the advertisement information to be selected and displayed according to this invention when the Web page is displayed by the Web browser. The Web advertisement indicated by the selected advertisement information is displayed in a space on the display where the selected advertisement is to be displayed by the script language such as JavaScript.

The “display viewing means” is what is called the Web browser and means the software (for example, Internet Explorer (trademark) or Mozilla Firefox (trademark)) to display the Web page while following the link of the hypertext in WWW (World Wide Web).

The “viewing history storage means” indicates a means for storing the history of the URL viewed by the display viewing means described above. The “viewing history candidate information” indicates the information on the URL of the Web page having an advertisement space with the advertisement expected to be placed therein, which the advertiser designates at the time of registering the advertisement information and which the advertiser is considered to have viewed before by the viewer. According to this invention, the advertiser presumes the profile of the desired viewer to reach his/her advertisement and designates, as the viewing history candidate information, the URL of the Web page (the home page of each leading automobile manufacturers, for example, in the case where a viewer interested in cars is presumed) which may interest and may be viewed by the particular viewer. As a result, the latent customer group having a predetermined behavioral pattern on Web can be grasped and an effective advertisement can be placed.

### BRIEF DESCRIPTION OF DRAWINGS

FIG. 1 is a schematic view showing an advertisement matching system according to an embodiment of this invention.

FIG. 2 is a block diagram showing a hardware configuration of an advertisement distribution server according to an embodiment of the invention.

FIG. 3 is a block diagram showing a hardware configuration of a viewing terminal according to an embodiment of the invention.

FIG. 4 is a diagram showing a file structure of an advertisement distribution data base 210 according to an embodiment of the invention.

FIG. 5 is a diagram showing an image of a medium information input screen according to an embodiment of the invention.

FIG. 6 is a diagram showing an image of an advertisement information input screen according to an embodiment of the invention.

FIG. 7 is a diagram showing an image of a medium search screen according to an embodiment of the invention.

FIG. 8A is a conceptual diagram showing a medium owner DB and 8B is a conceptual diagram showing a medium DB according to an embodiment of the invention.

FIG. 9A is a conceptual diagram showing an advertiser DB and 9B is a conceptual diagram showing an advertisement DB according to an embodiment of the invention.

FIG. 10 is a flowchart showing the flow of the medium registration process according to an embodiment of the invention.

FIG. 11 is a flowchart showing the flow of the advertisement registration process according to an embodiment of the invention.

FIG. 12 is a flowchart showing the flow of the process from the viewing request to the medium display according to an embodiment of the invention.

FIG. 13 is a diagram showing an image illustrating the step of collating the viewing history and the viewing history candidate.

FIG. 14 is a schematic view showing an advertisement matching system according to another embodiment of the invention.

FIG. 15 is a flowchart showing the flow of the process from the viewing request to the medium display according to another embodiment of the invention.

FIG. 16A is a diagram showing a screen image indicating an advertisement space AS on a medium (Web page), and 16B is a diagram of a screen image showing the state in which the advertisement information is inserted in the advertisement space.

### DESCRIPTION OF REFERENCE NUMERALS

100 Advertisement matching system
101 Advertisement distribution server (server)
102 Medium recording server
103 Network (electric communication line)
104 Viewing terminal
105 Medium owner terminal
106 Advertiser terminal
107 File server
201, 301 CPU
202, 302 ROM
203, 303 RAM
204, 304 Bus
205, 305 I/F
206, 306 Input device
207, 307 Display device
208, 308 External storage device
209, 309 Communication port
210 Advertisement distribution data base
310 Browser
401 Medium DB (medium attribute information storage means)
402 Medium owner DB
403 Advertisement DB (advertisement attribute information storage means)
404 Advertiser DB
405 Placement application DB
406 Placement DB (medium/advertisement-relation storage means)
407 Log DB
408 Report DB
409 Invoice/Payment DB
500 Medium owner advance registration screen
501 Site name input column
502 Site description input column
503 Site URL input column
504 Space situation input column
505 Advertisement type input column
506 Advertisement size input column
507 Category input column
508 Keyword input column
600 Advertiser advance registration screen
601 Advertisement group name input column
602 Advertisement type input column
603 Advertisement name input column
604 Advertisement image input column
605 Display URL input column
606 Link destination URL input column
700 Medium search screen
701 Medium owner column
702 Medium (site) name column
703 Advertisement type column
704 Average display number column
705 Average CPC column
706 UU number column
710 Search condition setting column
800 Medium owner DB
801 Medium owner column
802 Management site name column
803 Management site URL column
810 Medium DB
811 Site name column
812 Site description column
813 Site URL column
814 Space situation column
815 Advertisement type column
816 Advertisement size column
817 Category column
818 Keyword column
900 Advertiser DB
901 Advertiser column
902 Advertisement column
910 Advertisement DB
911 Advertisement group column
912 Advertisement type column
913 Display URL column
914 Link destination URL column
915 Advertisement image column
916 Status column
917 Payment status column
AS Advertisement space

### BEST MODE FOR CARRYING OUT THE INVENTION

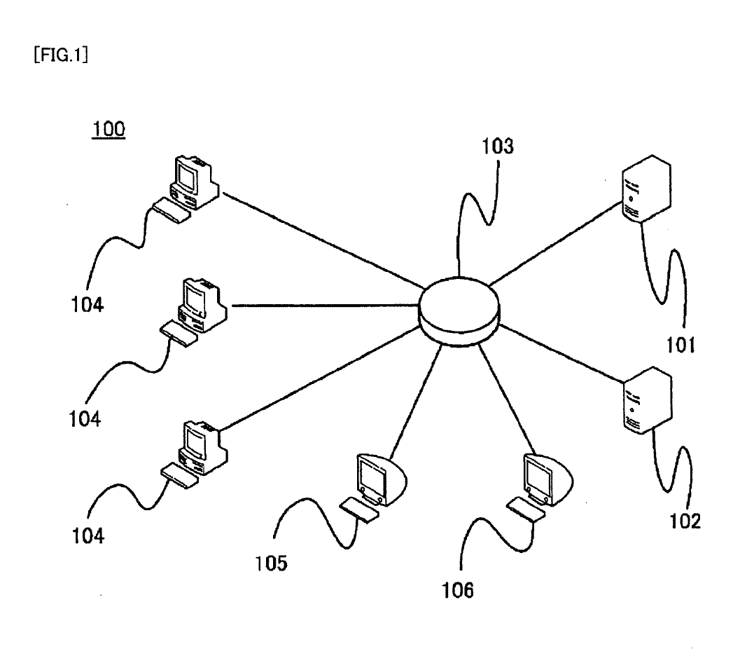

Specific embodiments of the invention are described below with reference to the drawings. FIG. 1 is a schematic view showing an outline of an advertisement matching system 100 according to an embodiment of this invention. An advertisement distribution server 101 and a medium recording server 102 are connected to multiple viewing terminals 104, . . . , 104 through a network 103. Also, a medium owner terminal 105 of a medium owner, i.e. a party providing an advertisement space on a Web page and an advertiser terminal 106 of an advertiser, i.e. a party desirous of placing an advertisement in an advertisement space on a Web page are similarly connected to the server 101 through the network 103.

In the advertisement matching system 100 according to this embodiment, the advertisement placement information from the advertiser and the medium information from the medium owner, i.e. the information on the advertisement space of the Web advertisement are registered by the access to the advertisement distribution server 101 from each of the advertiser terminal 106 and the medium owner terminal 105. Specific steps of this access are described later. The medium information and the advertisement information are matched with each other in the advertisement distribution server 101. Incidentally, by way of explanation, the viewing terminals 104, . . . , 104 are illustrated discriminatively from the medium owner terminal 105 and the advertiser terminal 106. Each terminal, however, is not limited to a specific function, but of course has only a different functional position on the system according to who to use the terminal for viewing the Web page, being desirous for the provision of an advertisement space as a manager of the Web page, or being desirous for the advertisement placement.

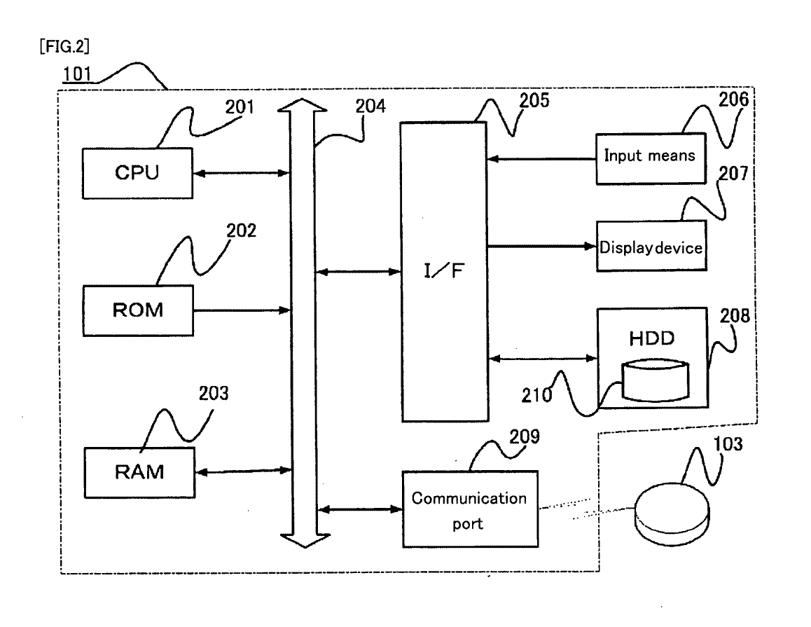

FIG. 2 is a block diagram showing a hardware configuration of the advertisement distribution server 101 of FIG. 1. The advertisement distribution server 101 includes a CPU 201, a ROM 202, a RAM 203, a bus 204, an I/F 205, an input means 206, a display device 207, a HDD 208 and a communication port 209.

The ROM 202 is a nonvolatile memory to store a basic program such as a boot program. The RAM 203 is a volatile memory used as an area to store programs and data, or as a working area to store the data used for the process executed by the CPU 201. These component parts are connected to the input means 206, the display device 207, the HDD 208 and the communication port 209 through the bus 204 and the I/F 205.

The input means 206 is a device through which an external operator performs the input operation, and specifically, constituted of but not limited to a mouse or a keyboard. The display device 207 is a device such as a liquid crystal display or a CRT display to display an image. Incidentally, the display device 207 according to this embodiment, though described as a configuration integrated with the server, is not of course limited to such a configuration and may alternatively be connected as an external device through, for example, an extension terminal (not shown).

The HDD 208 readably stores the OS (operating system) and various application software on the one hand and stores the holding data of the various application software. The application software naturally includes the data base software. The HDD 208 has recorded therein an advertisement distribution data base 210. The advertisement distribution data base 210 includes multiple relational data bases having a configuration described later.

The communication port 209 acts as an intermediary to exchange data with external devices. According to this embodiment, the communication port 209 is connected to the network 103, through which the data is exchanged with the viewing terminals 104, . . . , 104, the medium owner terminal 105 and the advertiser terminal 106.

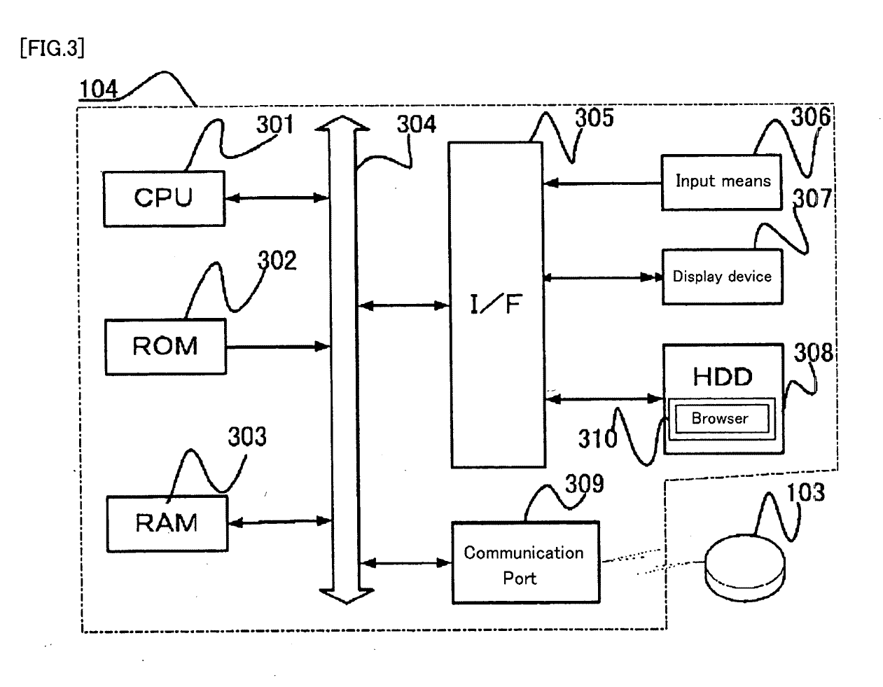

FIG. 3 is a block diagram showing a hardware configuration of the viewing terminal 104. Incidentally, this hardware configuration is not substantially different from the configuration of each component part shown in FIG. 2 in basic points, and configured of a CPU 301 having the arithmetic function, a ROM 302 providing a nonvolatile memory, and a RAM 303 which is a volatile memory functioning as an area to store programs and data and also to store the data for the arithmetic process executed by the CPU 301. These component parts are further connected to an input means 306, a display device 307, a HDD 308 and a communication port 309 through a bus 304 and an I/F 305.

The HDD 308 has recorded therein a browser 310 constituting the application software functioning at the time of displaying the Web page on the display device 307. Roughly, the browser 310 is configured of three parts including (a) a Web client communicating with the Web server to retrieve the information corresponding to a designated URL (Uniform Resource Locator), (b) a parser for analyzing the retrieved information according to the type thereof (for example, HTML, XHTML, XML, image or text), and (c) a renderer for arranging the image and text or adjusting the size and color of letters appropriately based on the result of analysis by the parser. The browser 310 according to this embodiment includes JavaScript as a script engine and realizes the advertisement display described later. The browser 310 functions as a medium display viewing means in collaboration with the CPU 301, the RAM 303 and the display device 307.

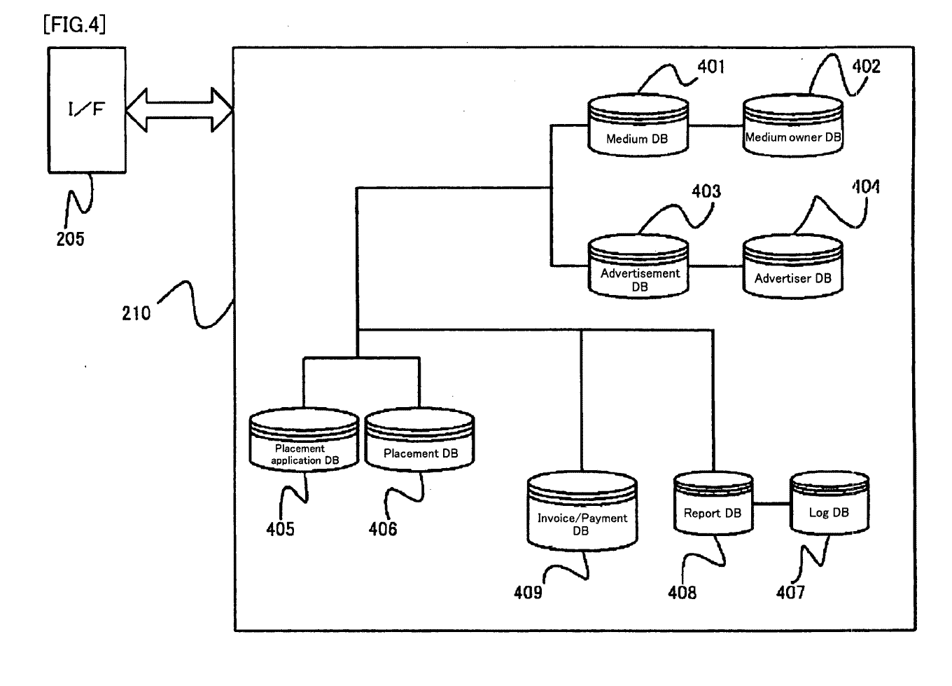

FIG. 4 is a diagram showing the configuration related to the advertisement distribution data base 210 described above. The advertisement distribution data base 210 is configured of a medium DB 401, a medium owner DB 402, an advertisement DB 403, an advertiser DB 404, a placement application DB 405, a placement DB 406, a log DB 407, a report DB 408 and an invoice/payment DB 409.

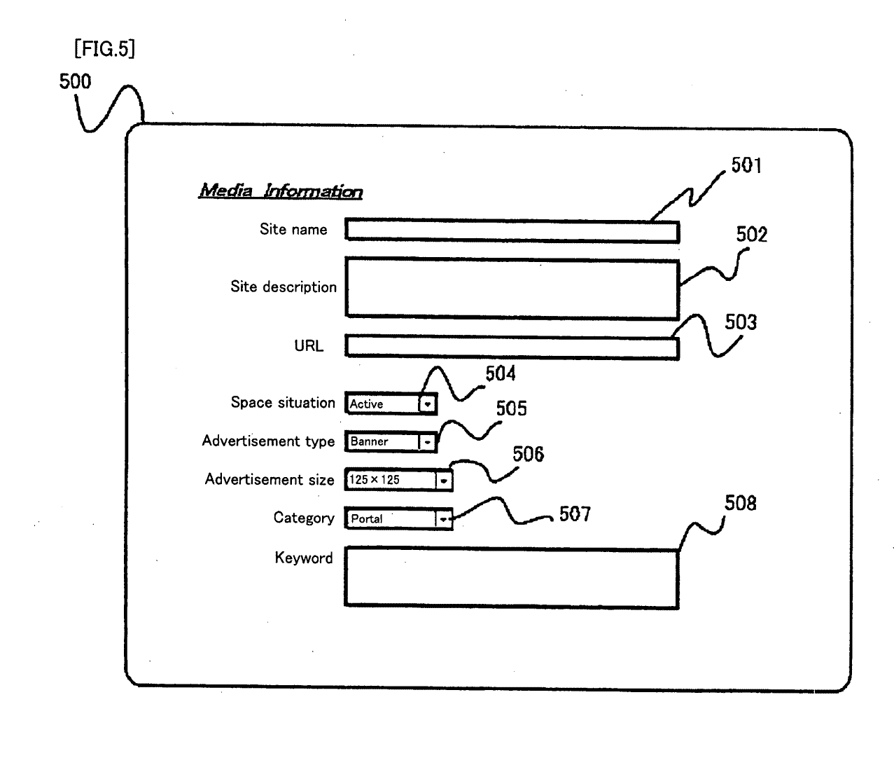

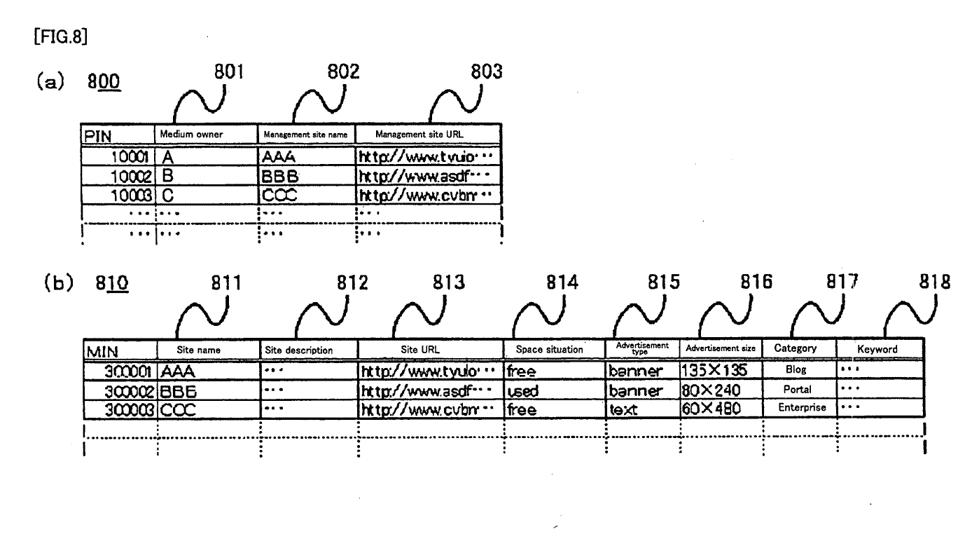

The medium DB 401 has the information on the advertisement placement space held by the medium owner. The medium owner DB 402 has the information on the profile of the medium owner. The information stored in the medium DB 401 and the medium owner DB 402 is registered in accordance with a medium information registration screen (FIG. 5) described later, by accessing the advertisement distribution server 101 from the medium owner terminal 105, and this data is stored as shown in the conceptual diagram of FIG. 8 illustrating the medium data storage. The medium DB 401 corresponds to the medium attribute information storage means.

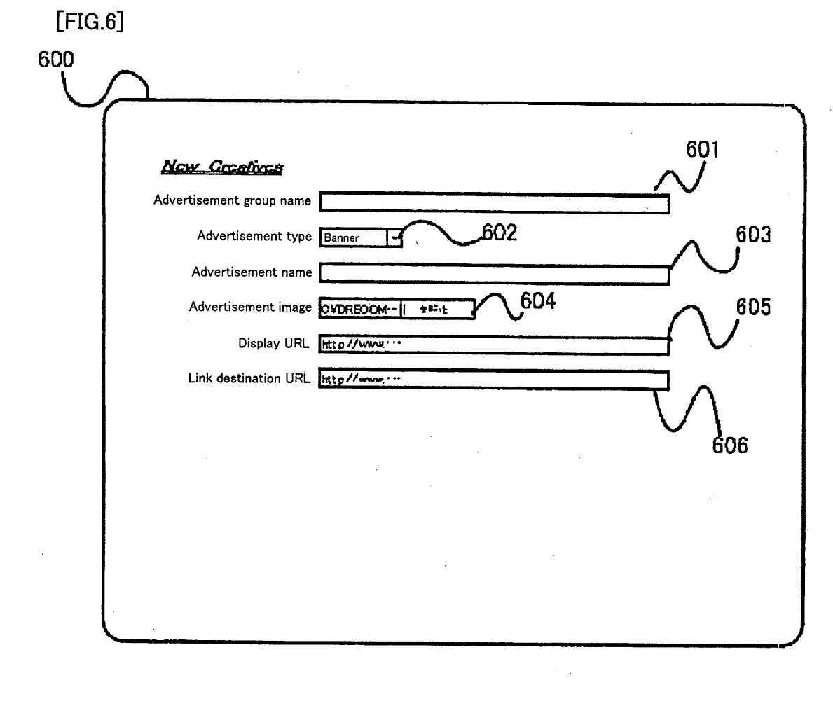

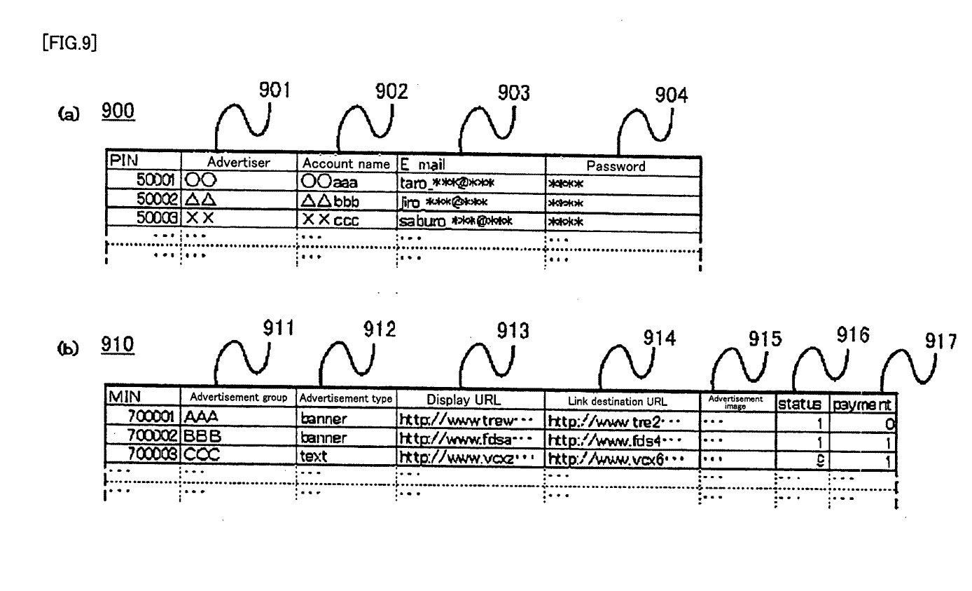

The advertisement DB 403 has the advertisement attribute information including the advertisement information placed by the advertiser. The advertiser DB 404 has the information on the profile of the advertiser. The information stored in the advertisement DB 403 and the advertiser DB 404 is registered in accordance with an advertisement information registration screen (FIG. 6) described later, by accessing the advertisement distribution server 101 from the advertiser terminal 106. This data is stored as shown in the conceptual diagram of FIG. 9 illustrating the advertisement data storage described later. The advertisement DB 403 corresponds to the advertisement attribute information storage means.

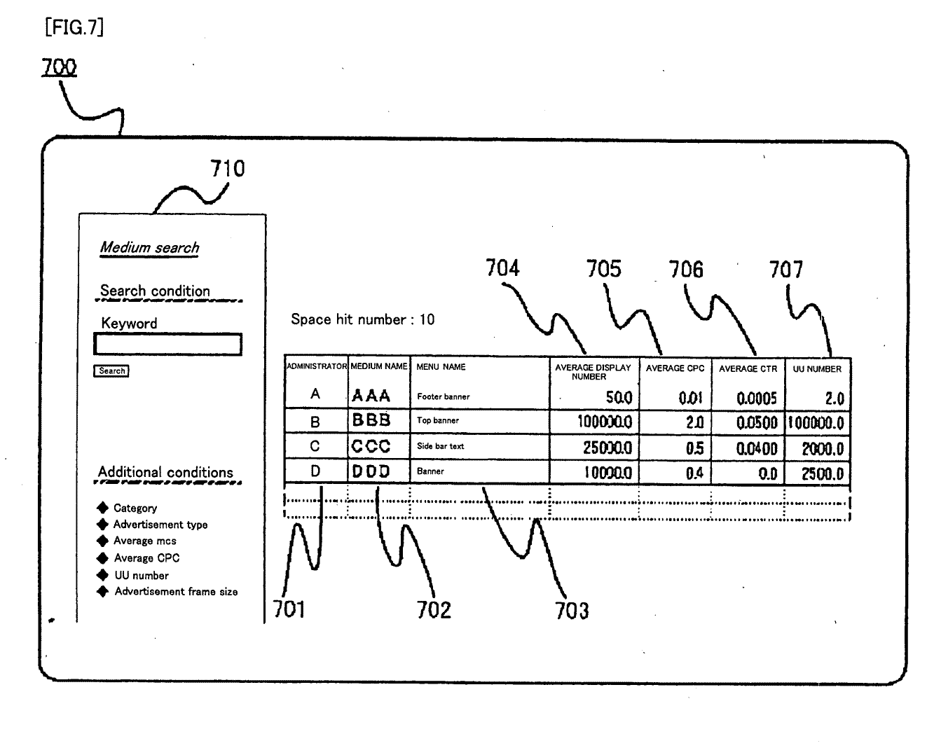

The placement application DB 405 has the information on the placement application from the advertiser and the response of the medium owner. The placement DB 406 has the information on the advertisement to be placed, the advertisement space, and the price and period for the placement. The advertiser, after registering his/her advertisement attribute information, searches for an advertisement space meeting the conditions for his/her placement on the medium search screen as shown, for example, in FIG. 7. After that, the placement application to the medium owner for the medium information in the advertisement space desired for placement is registered. As a result, the advertisement attribute information stored in the advertisement DB 403 and the medium attribute information stored in the medium DB 401 are stored in the placement application DB 405 in the form that the relationship is established. At the same time, the information on the request for placement of the medium information to the medium owner is sent to the medium owner terminal 105 through the I/F 205 and the communication port 209. Once the approval information from the medium owner terminal 105 is transmitted to the advertisement distribution server 101, the information thus far stored in the placement application DB is transferred to the placement DB 406. In this way, the intention of the medium owner to provide the space and the intention of the advertiser to place the advertisement come to coincide with each other, so that the advertisement attribute information related to the medium attribute information is prepared as a placement candidate to meet a viewing request, if any. The placement DB 406 corresponds to the medium/advertisement relation storage means.

The log DB 407 stores the log generated at the time of displaying the advertisement by placement and the particular advertisement being clicked. The log stored in the log DB 407 is periodically totalized and transmitted to the medium owner terminal 105 and the advertiser terminal 106 while at the same time being stored in a report DB 408. The invoice/payment DB 409 stores the information on the amount claimed to the advertiser and the amount paid to the medium owner with regard to the advertisement placement charge based on the report data stored in the report DB 408 and the advertisement placement conditions (CPC, etc.) stored in the placement DB 406.

As described above, the advertisement distribution data base 210 has stored therein the information on the medium and the advertisement in relation to each other. The data forming the base of the information are input by accessing the advertisement distribution server 101 from the medium owner terminal 105 and the advertiser terminal 106 through the network 103. FIG. 5 shows an example of the medium information registration screen for inputting the advertisement space information provided by the medium owner from the medium owner terminal 105. This screen has a site name input column 501, a site description input column 502, a site URL input column 503, a space situation input column 504, an advertisement type input column 505, an advertisement size input column 506, a category input column 506 and a keyword input column 507, in which the medium owner registers, freely or by choosing from candidates list, the advertisement space provided by himself/herself. According to this embodiment, the site URL input in the site URL input column 503 corresponds to the information on the URL of the Web page contained in the medium attribute information.

The input information is sequentially stored in the medium DB 401 and the medium owner DB 402. FIG. 8A is a conceptual diagram showing the file of the medium owner DB 402 (medium owner DB file 800) storing the information on the medium owner, and FIG. 8B a conceptual diagram showing the file of the medium DB 401 (medium DB file 810) storing the information on the medium (advertisement space). The input item of the medium owner column 801 is already registered at the time of user registration (not shown) by the medium owner. The management site name column 802 corresponds to the input item of the site name input column 501 shown in FIG. 5, and the management site URL column 803 to the input item of the URL input column 503 shown in FIG. 5 respectively.

Also, the site name column 811 on the medium DB file 810 corresponds to the input item of the input column of the site name input column 501 shown in FIG. 5, and the site description column 812 to the input item of the site description input column 502 shown in FIG. 5. The site URL column 813, like the management site URL column 803, corresponds to the input item of the URL input column shown in FIG. 5. The space situation 814 is a status indicating whether the placement application for the particular advertisement space has been filed or not and whether the placement application has been permitted or not. The advertisement type column 815 corresponds to the input item of the advertisement type input column 505 shown in FIG. 5, the advertisement size column 816 to the input item of the advertisement size input column 506 shown in FIG. 5, the category column 817 to the input item of the category input column shown in FIG. 5, and the keyword column 818 to the input item of the keyword input column shown in FIG. 5 respectively.

Incidentally, the advertisement type is selected from among a banner advertisement for displaying an image (icon) to jump to the URL of the link destination by clicking, an image advertisement with no such link set and a text advertisement with a text displayed. Also, the category indicates the property of the Web page constituting the medium. Also, the keyword is an arbitrary word selectable to feature the Web page constituting the medium, and with other elements, constitutes one of the search conditions for the medium search by the advertiser.

FIG. 6 shows an example of an advertisement information registration screen in which the advertiser inputs the advertisement information desired by the advertiser to place from the advertiser terminal 106. This screen includes an advertisement group name input column 601, an advertisement type input column 602, an advertisement name input column 603, an advertisement image storing place input column 604, a display URL input column 605 and a link destination input column 606 to register the advertisement which the advertiser desires to place freely or by choosing from the candidates list.

The input information is sequentially stored in the advertisement DB 403 and the advertiser DB 404. FIG. 9A is a conceptual diagram showing the file of the advertiser DB 404 (the advertiser DB file 910) storing the information on the advertiser, and FIG. 9B a conceptual diagram showing the file of the advertisement DB 403 (advertiser DB file 900) storing the information on the advertisement. The input item of the advertiser column 901 is already registered at the time of user registration by the advertiser. An account name 902 is a character string allotted for identification of the advertiser and stored in the form with relation to an E-mail address 903 and a password 904 used by the advertiser to log in.

On the advertisement information registration screen shown in FIG. 6, the advertiser sequentially inputs the information on the advertisement of which the placement is desired by him/her. The advertisement group name input column 601 is where the name indicating multiple advertisement groups concerning a predetermined product or service which are placed by the advertiser is input. The input result of this column corresponds to the advertisement group column 911 shown in FIG. 9B. The advertisement type input column 602 is where the type of the advertisement placed by the advertiser is input, and corresponds to the advertisement type column 912 shown in FIG. 9B. In the advertisement name 603, an individual advertisement name is input. In the advertisement image input column 604, the place to store the image or text data of the advertisement placed is designated. The input content corresponds to the advertisement image column 915 shown in FIG. 9B. The display URL input column 605 is the column where the URL for causing the viewer to remember the site of the jump destination with a short URL-type text data at the time of clicking the banner in displaying the particular advertisement data, and corresponds to the display URL column 913 shown in FIG. 9B. The link destination URL input column 606 is where the URL of the jump destination is input at the time of clicking the banner, and corresponds to the link destination URL column 914 shown in FIG. 9B.

Next, with reference to FIG. 7, the steps of searching for the advertisement space in which the advertiser places his/her advertisement is explained. In the left column of the medium search screen 700, a search condition input column 710 is provided. According to this embodiment, in addition to the keyword (freely input), the search conditions can be set by the category, the advertisement type, the average imps (indicating the impression number, or the number of times the advertisement is displayed), the average CPC(Cost Per Click; the unit advertisement cost per click in the case where the charge condition is the click charge), the UU number (the number of unique users; the number of persons who have visited the Web site or a specified page of the Web site) or the advertisement frame size. By doing so, the advertiser can determine the Web page in the field where the placement is desired by him/her, can search for a medium having at least a predetermined traffic, and can find a medium meeting his/her budget limitation.

In the central column of the medium search screen 700, the search result is displayed. According to this embodiment, the media hit are displayed in a list, and an administrator column 701, a medium name column 702, a menu name column 703, an average display number column 704, an average CPC column 705, an average CTR (Click Through Rate; the ratio of which the advertisement is clicked) column 706, and a UU number column 707 are displayed on the screen. The advertiser, based on these various indexes displayed, can determine the medium for placement.

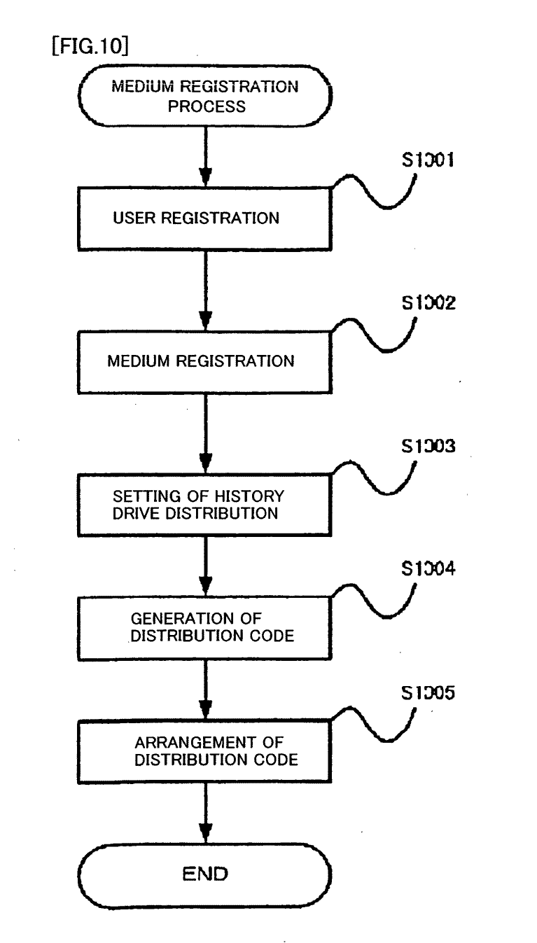

Next, with reference to the flowchart of FIG. 10, the flow of the process from the registration of the information on the medium (advertisement space) by the medium owner to the storage thereof in the advertisement distribution data base 210 is explained.

The medium owner registers the user by accessing the advertisement distribution server 101 from the medium owner terminal 105 through the network 102 (step S1001). In user registration, the account name, the E-mail address, the password, the name and whether the medium owner receives the message via E-mail when an application for advertisement placement is made by an advertiser are registered.

Next, the medium is registered (step S1002). In accordance with the medium registration screen previously shown in FIG. 5, predetermined information is input. Next, the history drive distribution is set (step S1003). In the case under consideration, selection is made as to whether the advertisement is to be distributed based on the history of the viewer or not. In the case where the advertisement is distributed based on the history of the viewer, the operation when the history information cannot be detected is set at the same time. The medium owner can set the conditions and a method for determining for the permission on placement of the advertisement in the advertisement space provided by him/her.

The advertisement distribution type is roughly classified into two types, “LockOn” and “CrossAd”. “LockOn” is an advertisement providing method of such a type that the medium owner offers a fixed advertisement price and signs an individual contract with the advertiser. In the case of “LockOn”, the advertiser studies the advisability of placing the advertisement and applies for placement while examining the price and other conditions offered by the medium owner. Incidentally, in the case of “LockOn”, the possibility of price negotiation from the advertiser can be set. As a result, the medium owner has a higher chance to sign a contract with the advertiser by offering the medium providing information under predetermined conditions while at the same time flexibly correcting the conditions.

“CrossAd”, on the other hand, is an advertisement space providing method of what is called the auction type in which the advertiser searches for the conditions meeting his/her desire (refer to FIG. 7) and can determine the CPC collectively for a list of results. Although this embodiment assumes that the medium owner cannot set the lower limit of CPC, the server administrator can set the lowest limit value (for example, 50 yen) to create a proper closing situation.

The history drive distribution can be set in any one of the two types described above. In view of the fact that the selective advertisement placement based on history drive is one of the placement conditions, however, “CrossAd” can produce a higher effect. The medium owner is aware that according to “LockOn”, the advertisement space is positively used under predetermined conditions, thereby leading to an advertisement profit. In the case of “CrossAd”, on the other hand, the advertiser intending to grasp, with pinpoint accuracy, the viewers passed through a specified viewing behavioral pattern, offers CPC of better conditions. By thus distributing the viewing history advertisement to the viewers passed through a specified viewing history, a higher chance to gain the advertisement profit is generated.

Incidentally, the medium owner can set the conditions for his/her advertisement space to “both”. In this case, (1) assuming that the LockOn advertisement contract is signed, the LockOn advertisement is distributed preferentially, and (2) the CrossAd advertisement is distributed complementarily. In the process, an advertisement reflecting the viewing history of a higher CPC is displayed and distributed to the viewer having a specified viewing history.

Also, in this step, the advertisement to be actually placed is verified by the medium owner to approve the placement. This is by reason of the fact that in the case where the advertisement to be placed has the content inappropriate to the medium (Web page) of the medium owners, for example, antisocial or obscene connotation, the advertisement placement can be rejected at the discretion of the medium owner. Incidentally, this process can alternatively be set by the medium owner in such a manner that the advertisement placement is always approved not to necessitate the confirmation on each occasion.

After that, based on the registered medium setting, the advertisement distribution server 101 generates a distribution code (step S1004). The distribution code thus generated is arranged at the desired position set by the medium owner in the medium information stored in the medium recording server 102 (step S1005). This distribution code is the data corresponding to the advertisement space set on the medium (Web page) and contains the description written in JavaScript about the conditions of the advertisement to be inserted.

Incidentally, according to this embodiment as shown in FIG. 1, the advertisement distribution server 101 and the medium recording server 102 are described as physically different entities. This invention, however, is not limited to this configuration, but both may be configured as the physically same server on the system.

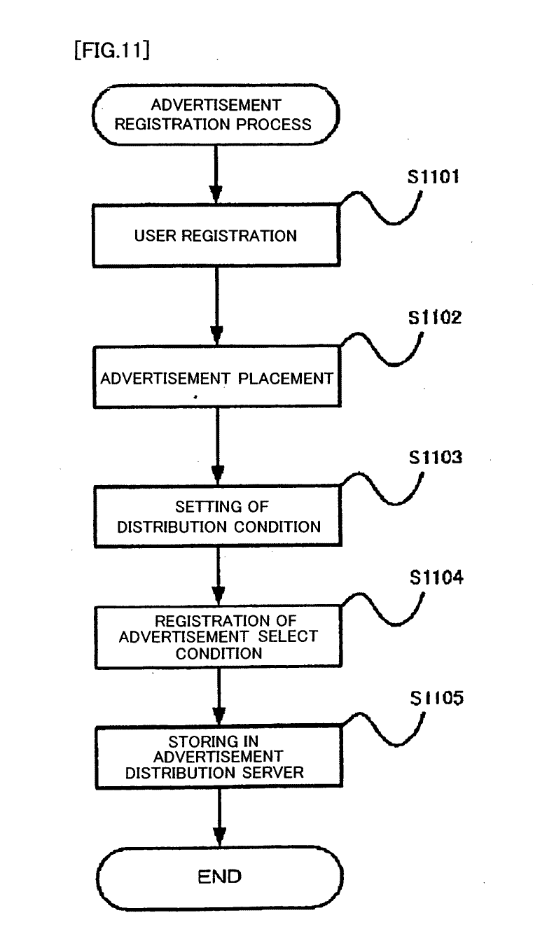

Next, with reference to FIG. 11, the flow of the process from the registration of the advertisement information which the advertiser is desirous of placing to the storage thereof in the advertisement distribution database 210. Like for the medium registration, the advertiser first connects the advertiser terminal 106 to the advertisement distribution server 101 through the network 102. The advertiser makes the user registration of himself/herself (step S1101). The user information includes the name, the account name, the E-mail address, the log-in password of the advertiser, and the like.

Next, the process for advertisement placement is executed (step S1102). In accordance with the advertisement information registration screen proposed previously in FIG. 6, the advertisement group name, the advertisement type, the advertisement image, etc. are sequentially input. After that, the distribution condition is set (step S1103). As described above, the placement application method is selected from the “LockOn” or “CrossAd” methods. Also, the conditions for placement application (placement period, charge method, CPC for click charge and whether the history drive distribution is enabled or not) are determined.

In the case where the placement application conditions described above includes the history drive distribution “enabled”, the advertisement select condition is further registered (step S1104). Here, the URL (viewing history candidate) and importance of other Web pages are set which may have so far been viewed by the viewer before viewing the medium (Web page) in which the advertisement is scheduled to be placed. In the case where the advertiser is desirous of placing an advertisement on the sale of used cars aimed at the viewers who have viewed the home pages of other dealers, then the URL of the home page of each of the particular dealers is registered as a viewing history candidate. By doing so, an advertisement can be placed which can efficiently grasp the viewer group more interested in used cars.

The registered information (user information, advertisement information, distribution conditions and advertisement select conditions) are distributed among predetermined DBs according to the nature of the particular information while relating them with each other, and stored in the advertisement distribution server 101 (step S1105). In the case where an application for advertisement placement has been specifically filed and the medium owner has approved it or the automatic approval is set, then the advertisement information is stored in the placement DB 406 with the relationship established to the predetermined medium information stored beforehand in the medium DB 401. After that, in the case where the viewer views the particular medium (Web page), the advertisement is distributed according to the set conditions. In the case where the approval of the medium owner has yet to be obtained, the advertisement information is stored in the placement application DB 405 and, upon registration of the approval of the medium owner, transferred to the placement DB 406. The placement DB 406 according to this embodiment corresponds to the medium/advertisement relation storage means.

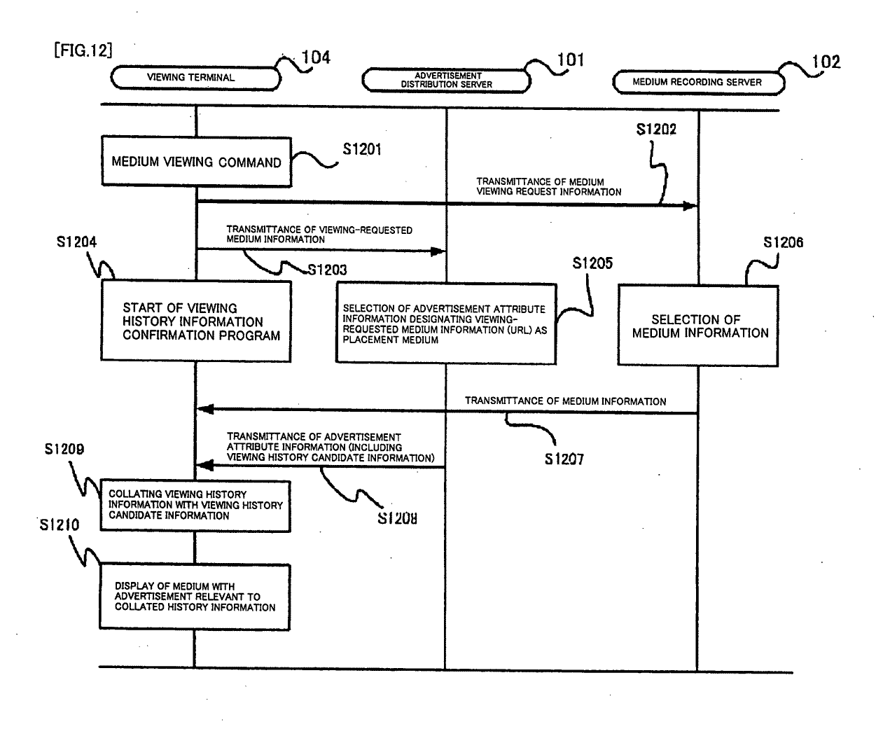

Next, with reference to the flowchart of FIG. 12, the flow of the process from the transmission by the viewer of the information to view the registered medium to the display of an advertisement matching an advertisement space on the particular medium is explained.

Once a medium viewing command is input from the input device 306 of the viewing terminal 104 (step S1201), the medium viewing request information is sent to the medium recording server 102 through the network 102 (step S1202), while at the same time sending the viewing-requested medium information to the advertisement distribution server 101 (step S1202). This viewing-requested medium information may take any form as far as it contains the URL of the Web page for which the viewing request is issued to the medium recording server 102.

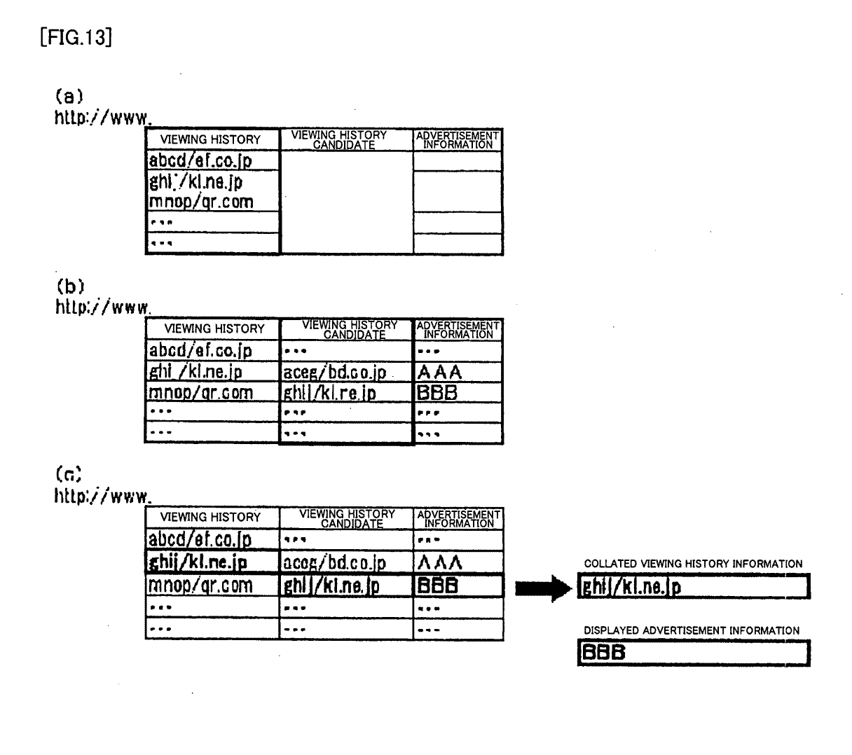

At the same time, the viewing history information confirmation program (Sniffer) is started at the viewing terminal 104 (step S1204). This is intended to extract the URL from the history information recorded in the browser. FIG. 13 is a conceptual diagram showing the flow of the process of collating the viewing history information with the viewing history candidate information. As shown in FIG. 13A, a list of URLs actually viewed is generated (defined by thick frame). In the process, a list of URLs viewed is generated which includes “(http://www.)abcd/ef.co.jp”, “(http://www.)ghij/kl.ne.jp”, “(http://www.)mnop/qr.com”, etc. The viewing history information confirmation program functions as a viewing history storage means and a viewing history confirmation means.

The advertisement distribution server 101 that has received the viewing-requested medium information specifies the medium based on the information on the medium-specifying URL contained in the specific information. Then, among the advertisement attribute information recorded in the form related to the medium attribute information stored in the placement DB 406, the advertisement attribute information (necessarily containing the information on the URL as the placement medium information included therein) having the same specified medium (URL) as the one contained in the medium attribute information is selected and extracted (step S1205). In the process, the advertisement distribution server 101 functions as an advertisement attribute information extraction means.

On the other hand, the medium recording server 102 selects the medium information corresponding to the viewing request information received (step S1206), and sends the medium information to the viewing terminal 104 which has issued the viewing request (step S1207). Incidentally, as explained already that the advertisement distribution server 101 and the medium recording server 102, though having different physical configurations for the convenience of explanation, are not limited to this configuration, but each may be configured as a single server, respectively. In such a case, the medium viewing request information sent in step S1202 and the viewing-requested medium information sent in step S1203 constitute substantially the same transmission object.

The advertisement distribution server 101 sends the extracted advertisement attribute information to the viewing terminal 104 that has transmitted the viewing request (step S1208). This advertisement attribute information contains, in addition to the information on the URL of the Web page designated as a placement medium, the viewing history candidate information to confirm the coincidence with the viewing history as a condition for displaying the particular advertisement and the advertisement information of the advertisement actually displayed on the display device 307 of the viewing terminal. In this case, the viewing history candidate information is defined as the information on the URLs of the Web pages viewed in the past through a browser 310 at the viewing terminal 104, and by designating the URL of the desired site, a particular site can be reflected that has been viewed in the past by the target viewers to be grasped as proposed viewers desirably reached by the advertiser. The RAM 202 of the advertisement distribution server 101, the bus 204 and the communication port 209 function as an extracted advertisement attribute information transmission means in step S1208.

The viewing terminal 104 that has received the advertisement attribute information containing the viewing history candidate information collates the previously generated viewing history with the received viewing history candidate (step S1209; FIG. 13B). As a result, the advertisement attribute information containing the coincident URL (FIG. 13(c)) as the viewing history candidate is specified. In the case under consideration, the collation shows the coincidence of “(http://www)ghij/kl.ne.jp”. Therefore, the advertisement information contained in the advertisement attribute information containing this URL as the viewing history candidate information is synthesized by the browser 310 with the medium information previously received by the viewing terminal, and displayed on the display means 307 (step S1210).

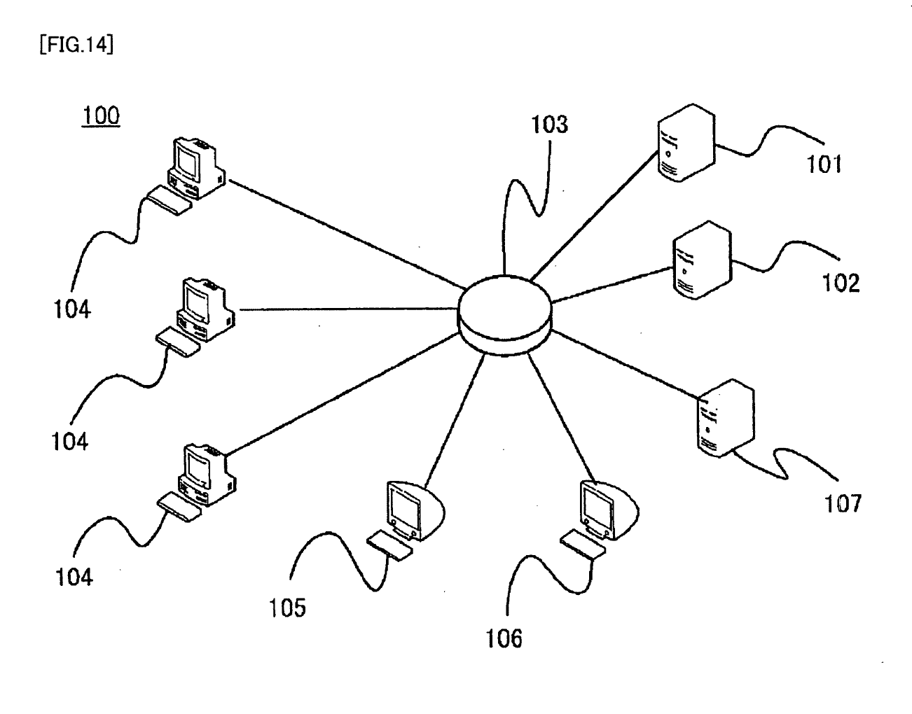

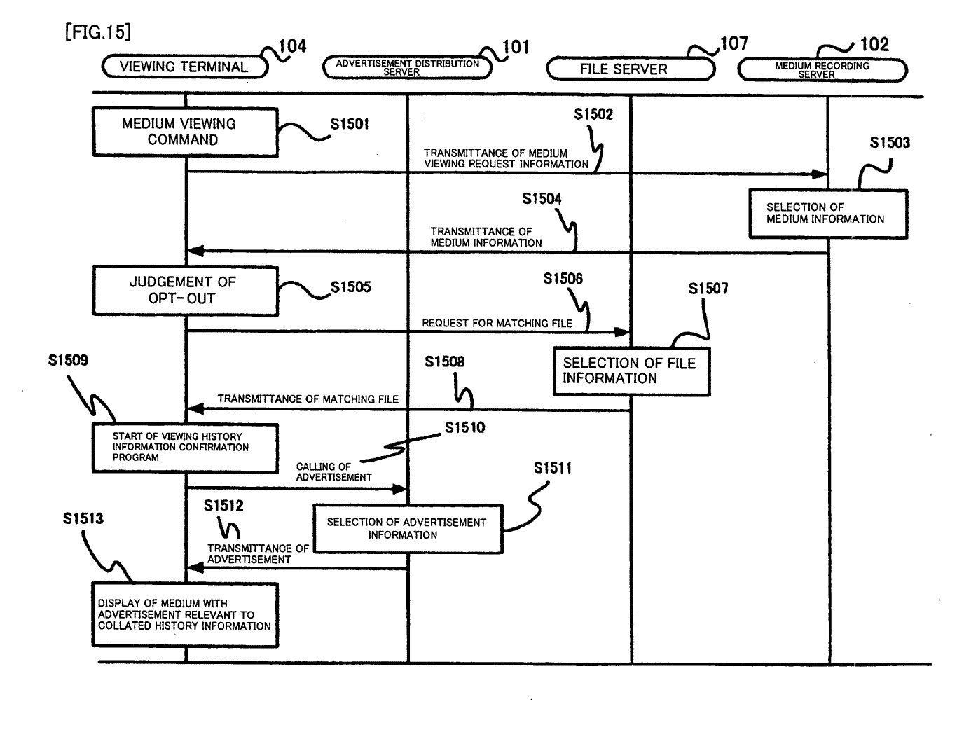

Next, the flow of the process in the advertisement matching system according to another embodiment of the invention is explained with reference to FIGS. 14 and 15. Incidentally, the same component parts as those included in the embodiment described above are denoted by the same reference numerals, respectively, and not described any more. FIG. 14 is a schematic view showing the advertisement matching system according to another embodiment of the invention. The difference from the embodiment described previously lies in the provision of a file server 107. The file server 107 stores therein program files (JavaScript, swf, etc.) to perform the advertisement matching at the viewing terminal, and the program files are distributed to the viewing terminal along the flow of the process described below. The correlation of the system parts including the file server 107 is explained with reference to FIG. 15 showing the flow of the process executed by the nodes based on the time series.

Once a medium viewing command is input from the input device 306 of the viewing terminal 104 (step S1501), the medium viewing request information is transmitted through the network 102 (step S1502). The medium recording server 102 that has received the request selects the medium information corresponding to the request (step S1503), and sends the medium information to the requested viewing terminal 104 (step S1504). Incidentally, the medium (content) transmitted is embedded therein with a tag for advertisement matching in advance, and the advertisement matching is performed at the viewing terminal in cooperation with the program file transmitted from the file server described later.

Next, the viewing terminal 104 judges whether the opt-out setting is done for that the advertisement matching is enabled or not (step S1505). This setting is performed in view of the fact that in the case where the tag for advertisement matching is embedded in the medium of which the viewing is requested by the viewer, the viewer may not be desirous of the execution thereof, and the advertisement distribution reflecting the viewing history of the viewer can be prevented with advance registration setting by the viewer. In this way, the privacy of the user can be protected.

Upon judgment that the opt-out setting is disabled, the viewing terminal 104 requests a matching file from the file server 107 (step S1506). The file server 107 selects a corresponding matching file (step S1507), and sends the matching file to the requesting viewing terminal 104 (step S1508).

Next, the viewing terminal 104 starts the viewing history information confirmation program (step S1509). The advertisement information to be accessed is determined, as shown conceptually in FIG. 13, by the matching tag contained in the medium information received from the medium recording server 102 and the program file received from the file server 107. The viewing terminal 104 accesses the advertisement distribution server 101 to retrieve the advertisement information determined as the result of matching (step S1510). The advertisement distribution server 101 selects the corresponding advertisement information (step S1511), and transmits the advertisement information to the viewing terminal that has issued a request (step S1512). The medium information previously received is combined with the received advertisement information by the viewing terminal and displayed on the display device 307.

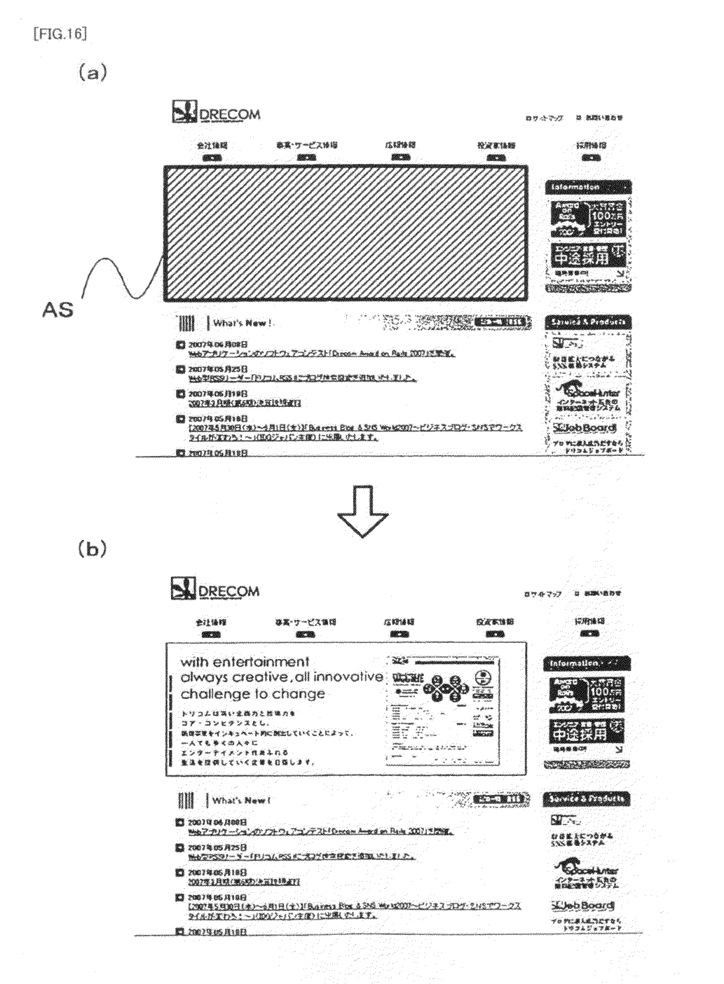

FIG. 16 shows the state in which the advertisement distributed by the advertisement distribution server 101 is inserted and displayed in the advertisement space set on the registered medium (Web page). As shown in FIG. 16A, the display space AS for advertisement on the medium is allotted to the data in advance. In step S1207 shown in FIG. 12, the medium information on the areas other than the area corresponding to the display space AS for advertisement is transmitted to the viewing terminal 104 that has issued the viewing command from the medium recording server 102. Then, any one of the advertisement information transmitted in step S1208 shown in FIG. 12 and contained in the advertisement medium information in step S1209 is selected as the advertisement information to be displayed. The browser 310 of the viewing terminal 104, based on these two pieces of information, displays the advertisement indicated by the advertisement information received from the advertisement distribution server 101, in the display space AS for advertisement as shown in FIG. 16B.

As described above, in the advertisement matching system according to this embodiment, the advertiser can conduct the promotion activities concentrated on the viewers exhibiting a specified viewing behavior, and thus can place the advertisement by more detailed target segmentation. This merit is not limited to the advertiser but also leads to a motive on the part of the medium owner to increase the unit price of each advertisement placement. Further, an advertisement in the field more interesting to the viewer is selectively displayed, thereby contributing to the proper purchase activity.

1. An advertisement matching system having a server and viewing terminals connected to the server through an electric communication line to match a Web advertisement and an advertisement space on a Web:
the server comprising:
a medium attribute information storage means for registering the medium attribute information containing the information relating to a specific Web page and at least the information on the URL of the Web page;
an advertisement attribute information storage means for registering the advertisement attribute information containing the information relating to a specific Web page and at least the placement medium information relevant to the URL of the Web page designated as a placement medium, the viewing history candidate information as a condition to display the advertisement and the advertisement information to be displayed;
a medium/advertisement relation storage means which, on condition that the information relevant to the URL of the Web page contained in the medium attribute information coincides with the placement medium information contained in the advertisement attribute information, stores the coincident medium attribute information and the coincident advertisement attribute information with the relationship of each other in accordance with an external command;
an advertisement attribute information extraction means for extracting the advertisement attribute information in the case where the information relevant to the URL contained in the viewing-requested medium information received from the viewing terminal coincides with the placement medium information contained in the advertisement attribute information stored in the medium/advertisement relation storage means; and
an extracted advertisement attribute information transmission means for transmitting the extracted advertisement attribute information to the viewing terminal which has transmitted the viewing-requested medium information; and
each of the viewing terminals comprising:
a medium display viewing means for displaying and viewing the Web page received through the electric communication line, along with the Web advertisement transmitted from the server;
a viewing history storage means activated at the time of activation of the medium display viewing means to store the viewing history of the URLs of the Web pages viewed using the medium display viewing means; and
a viewing history confirmation means for confirming whether the viewing history candidate information contained in the extracted advertisement attribute information received from the server is contained in the viewing history stored in the viewing history storage means or not;
wherein the advertisement information contained in the advertisement attribute information containing, as the viewing history candidate information, the URL confirmed by the viewing history confirmation means to have the viewing history is displayed in an advertisement space on the Web page requested to view.

2. The advertisement matching system as described in claim 1, wherein the medium attribute information includes the advertisement space information in the Web page.

3. The advertisement matching system as described in claim 1, wherein the medium attribute information further includes a Web site name, a category and a keyword.

4. The advertisement matching system as described in claim 1 further comprising a viewing history confirmation rejection means for preventing the viewing history confirmation means from functioning by the input from an external source.

5. An advertisement providing method for providing by matching the advertisement information stored in a server, with an advertisement space on a Web page on a display device of a viewing terminal connected through an electric communication line comprising:
the step in which the server stores the medium attribute information containing the information relating to a specific Web page, constituting at least the information relevant to the URL of the Web page;
the step in which the server stores the advertisement attribute information relevant to the specific Web advertisement which contains the placement medium information relevant to the URL of the Web page designated at least as a placement medium, the viewing history candidate information as a condition for displaying the advertisement and the advertisement information to be displayed;
the step in which, on condition that the information relevant to the URL of the Web page contained in the medium attribute information coincides with the placement medium information contained in the advertisement attribute information, the server stores the coincident medium attribute information and the coincident advertisement attribute information in accordance with an external command;
the step in which the server extracts the advertisement attribute information in the case where the information relevant to the URL of the Web page requested to view coincides with the placement medium information contained in the advertisement attribute information stored with the relationship of each other;
the step in which the server transmits the extracted advertisement attribute information to the viewing terminal which has transmitted the viewing-requested medium information;
the step in which the viewing terminals each confirms whether the viewing history candidate information contained in the extracted advertisement attribute information received from the server is contained in the viewing history stored in the viewing history storage means of the viewing terminal; and
the step in which the viewing terminal displays, in the advertisement space on the Web page requested to view, the advertisement information contained in the advertisement attribute information containing, as the viewing history candidate information, the URL confirmed to have the viewing history.

6. The advertisement providing method as described in claim 5, wherein the medium attribute information further includes the advertisement space information of the Web page.

7. The advertisement providing method as described in claim 5, wherein the medium attribute information further includes a Web site name, a category and a keyword.

8. An advertisement matching program according to which advertisement information distributed from an advertisement distribution server is displayed in an advertisement space on a Web page requested to view, wherein a computer comprises:
a viewing history collation means in which the viewing history candidate information contained in the advertisement attribute information distributed from the server is collated with the viewing history information generated separately; and
an advertisement display means in which the advertisement information contained in the advertisement attribute information containing the viewing history candidate information confirmed as coincident by the viewing history collation means is displayed in the advertisement space on the Web page requested to view.

9. An advertisement display program according to which the advertisement information distributed from an advertisement distribution server is displayed in a specific advertisement space in the case where a specific condition is met, wherein a computer as comprises:
a viewing history collation means in which the viewing history candidate information contained in the advertisement attribute information distributed from the server is collated with the viewing history information generated separately; and
an advertisement display means for displaying the advertisement information contained in the advertisement attribute information containing the viewing history candidate information confirmed as coincident by the viewing history collation means;
wherein the specific condition is the coincidence between the viewing history candidate information contained in the advertisement attribute information distributed from the server and the viewing history information generated separately, as the result of the collation by the computer; and
wherein the specific advertisement space is an advertisement space defined in advance on the Web page of the URL designated as a placement medium contained in the advertisement attribute information and requested to view.

10. An advertisement distribution server for distributing the advertisement medium information containing the advertisement information meeting a specific condition to a viewing terminal comprising:
a medium attribute information storage means for registering the medium attribute information on a specific Web page;
an advertisement attribute information storage means for registering the advertisement attribute information as the information relevant to a specific Web advertisement, containing at least the information relevant to the URL of a Web page with the advertisement to be displayed thereon, the viewing history candidate information as a condition for displaying the advertisement and the advertisement information to be displayed;
a medium/advertisement relation storage means which, on condition that the information relevant to the URL of the Web page contained in the medium attribute information is coincident with the information relevant to the URL of the Web page with the advertisement to be displayed thereon and contained in the advertisement attribute information, stores the coincident medium attribute information and the coincident advertisement attribute information with the relationship of each other, in accordance with an external command;
an advertisement attribute information extraction means for extracting the advertisement attribute information stored in the medium/advertisement relation storage means in the case where the information relating to the URL contained in the viewing-requested medium information received from the viewing terminal is coincident with the information relevant to the URL of the Web page for displaying the advertisement contained in the advertisement attribute information; and
an extracted advertisement attribute information transmission means for transmitting the extracted advertisement attribute information to the viewing terminal which has transmitted the viewing-requested medium information.

11. The server as described in claim 10, wherein the medium attribute information includes the advertisement space information in the Web page.

12. The server as described in claim 10, wherein the medium attribute information further includes a Web site name, a Web site URL, a category and a keyword.

13. An advertisement matching system having a server and viewing terminals connected to the server through an electric communication line to match a Web advertisement and an advertisement space on the Web page, wherein:
each of the viewing terminals includes at least:
a display viewing means in which the Web page received through the electric communication line is displayed and viewed along with the Web advertisement transmitted from the server; and
a viewing storage means activated at the activation of the display viewing means to store the URL of the Web page viewed through the display viewing means; and
the server which includes:
a medium attribute information storage means for registering the medium attribute information relevant to a specific Web page;
an advertisement information storage means for registering the advertisement information containing, as the information on a specific Web advertisement, the viewing history candidate information at the viewing terminal;
a medium/advertisement matching means in which the specific medium attribute information registered in the medium attribute information storage means is relevant to the specific advertisement information registered in the advertisement information storage means;
a viewing history confirmation means in which the viewing history stored in the viewing storage means is confirmed in the case where the Web page having registered therein the medium attribute information is accessed from the viewing terminal through the electric communication line;
an advertisement information selection means for selecting the advertisement information containing, as the viewing history candidate information, the URL confirmed by the viewing history confirmation means to have been viewed; and
an advertisement information transmission means for transmitting the selected advertisement information to the viewing terminal.

14. An advertisement providing method for providing by matching a Web advertisement provided through an electric communication line with an advertisement space on a Web page, comprising:
the step in which a server stores the medium attribute information relevant to a specific Web page;
the step in which the server stores the advertisement information relevant to a specific Web advertisement;
the step in which the server transmits the viewing history candidate information contained in the advertisement information to the viewing terminal in the case where the viewing terminal requests the server to access the specific Web page;
the step in which the viewing terminal collates the viewing history candidate information with the viewing history candidate stored in the viewing means of the viewing terminal;
the step in which the viewing history information determined coincident by the collation is sent to the server by the viewing terminal;
the step in which the server selects the advertisement information based on the coincident viewing history information; and
the step in which the server sends the selected advertisement information to the viewing terminal.

15. A server comprising:
a medium attribute information storage means for registering the medium attribute information relating to a specific Web page;
an advertisement information storage means for registering, as the information relevant to the specific Web advertisement, the advertisement information containing the viewing history candidate information at the viewing terminal;
a medium/advertisement matching means in which the specific medium attribute information registered in the medium attribute information storage means is relevant to the advertisement information;
a viewing history confirmation means in which the viewing history stored in the viewing storage means is confirmed in the case where the Web page with the medium attribute information registered therein is accessed from the viewing terminal connected through the electric communication line;
an advertisement information selection means for selecting the advertisement information containing, as the viewing history candidate information, the URL confirmed by the viewing history confirmation means to have been viewed; and
an advertisement information transmission means for transmitting the selected advertisement information to the viewing terminal.

16. The server as described in claim 15, wherein in the case where the medium attribute information relevant to the Web page accessed by the viewing terminal is related to the advertisement information by the medium/advertisement matching means, the viewing history confirmation means transmits the viewing history candidate contained in the advertisement information to the viewing terminal through the electric communication line, and receives through the electric communication line, the viewed-or-not-viewed information generated at the viewing terminal.
